(19) United States
(12) Patent Application Publication
(10) Pub. No.: US 2014/0160017 A1
(43) Pub. Date: Jun. 12, 2014

(54) ELECTRONIC APPARATUS CONTROLL METHOD FOR PERFORMING PREDETERMINED ACTION BASED ON OBJECT DISPLACEMENT AND RELATED APPARATUS THEREOF

(71) Applicant: PIXART IMAGING INC., Hsin-Chu City (TW)

(72) Inventors: Yu-Hao Huang, Hsin-Chu City (TW); Yi-Fang Lee, Hsin-Chu City (TW); Ming-Tsan Kao, Hsin-Chu City (TW); Sen-Huang Huang, Hsin-Chu City (TW)

(73) Assignee: PixArt Imaging Inc., Hsin-Chu City (TW)

(21) Appl. No.: 13/865,172

(22) Filed: Apr. 17, 2013

(30) Foreign Application Priority Data
Dec. 11, 2012 (TW) 101146691

(51) Int. Cl. G06F 3/01

(52) U.S. Cl. CPC G06F 3/017
USPC 345/157; 345/156

(57) ABSTRACT

An electronic apparatus controlling method includes: determining if displacement of an object in a first predetermined time period is smaller than a first predetermined distance to generate a determining result; and controlling the electronic apparatus to perform a first predetermined action if the determining result is no, and controlling the electronic apparatus to perform a deciding step if the determining result is yes. The deciding step is utilized for deciding if a second predetermined action is performed according to a coordinates of the object at the end of the first predetermined time period.

### BACKGROUND OF THE INVENTION

1. Field of the Invention

The disclosed embodiments of the present invention relate to an electronic apparatus control method and electronic apparatus utilizing the electronic apparatus control method, and more particularly, to an electronic apparatus control method for performing click action in a remote manner and electronic apparatus utilizing the electronic apparatus control method.

2. Description of the Prior Art

In recent years, somatosensory technology is gradually mature and utilized in a variety of fields. For example, a variety of game consoles, including Nintendo's Wii video game console, use such technology to give the game a great diversity of presentations. However, such technology which detects movements of an object without having any contact with the physical device has difficulty in performing the click action.

### SUMMARY OF THE INVENTION

With this in mind, one of the objectives of the present invention is to provide an electronic apparatus control method to facilitate execution of the click action and related electronic apparatus utilizing the electronic apparatus control method.

According to a first aspect of the present invention, an electronic apparatus control method is disclosed. The electronic apparatus control method includes: determining if displacement of an object in the air in a first predetermined time period is smaller than a first predetermined distance to generate a determining result; and if the determining result is no, controlling the electronic apparatus to perform a first predetermined action, else if the determining result is yes, controlling the electronic apparatus to perform a deciding step, wherein the deciding step is utilized for deciding if a second predetermined action is performed according to a coordinates of the object at the end of the first predetermined time period.

According to a second aspect of the present invention, an electronic apparatus is disclosed. The electronic apparatus includes an object displacement detection apparatus and a control unit. The object displacement detection apparatus is arranged for determining displacement of an object in the air. The control unit is arranged for determining if the displacement of the object in the air in a first predetermined time period is smaller than a first predetermined distance to generate a determining result, if the determining result is no, controlling the electronic apparatus to perform a first predetermined action, else if the determining result is yes, controlling the electronic apparatus to perform a deciding step, wherein the deciding step is utilized for deciding if a second predetermined action is performed according to a coordinates of the object at the end of the first predetermined time period.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic apparatus according an embodiment of the present invention.

FIG. 2 is a diagram illustrating the first predetermined action performed by the electronic apparatus.

FIG. 3A is another diagram illustrating the first predetermined action performed by the electronic apparatus.

FIG. 3B is yet another diagram illustrating the first predetermined action performed by the electronic apparatus.

FIG. 4A is a diagram illustrating the deciding action performed by the electronic apparatus.

FIG. 4B is a diagram illustrating the deciding action performed by the electronic apparatus.

FIG. 5 is a diagram illustrating the deciding action performed by the electronic apparatus.

FIG. 6 is a diagram illustrating an electronic apparatus control method according an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

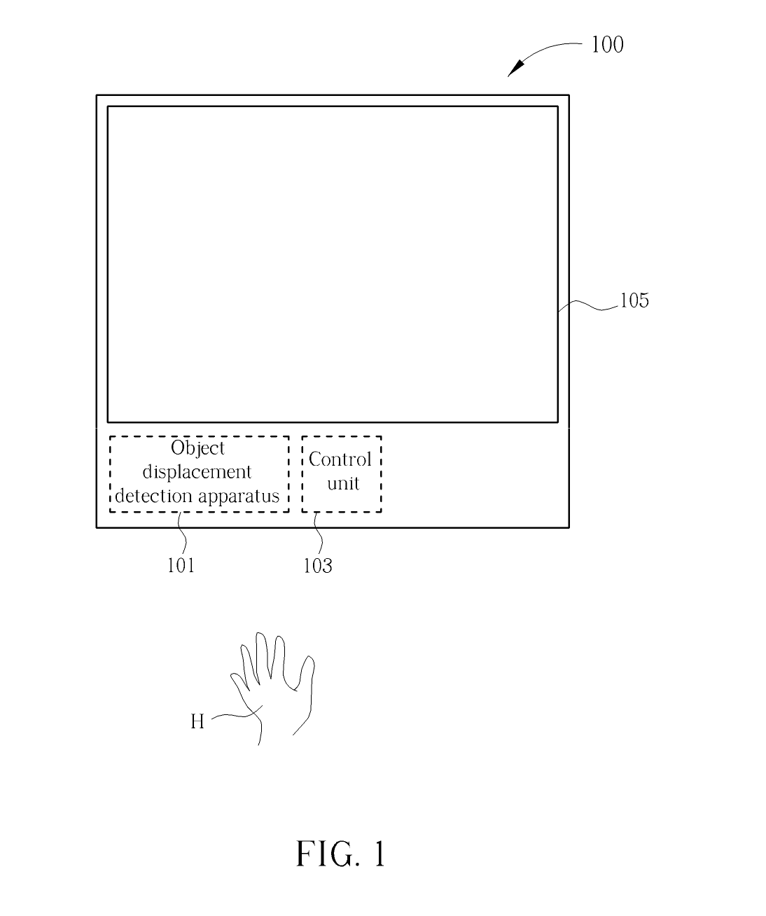

FIG. 1 is a diagram illustrating an electronic apparatus 100 according an embodiment of the present invention. As shown in FIG. 1, the electronic apparatus 100 includes an object displacement detection apparatus 101 and a control unit 103. The object displacement detection apparatus 101 is used to detect displacement of an object in the air. This embodiment will be described with reference to a palm H; however, the objects detected by the object displacement detection apparatus 101 can also be other objects such as finger(s) or a controller. The control unit 103 determines whether the displacement of the palm H in the air within a first predetermined time period is smaller than a first predetermined distance, and accordingly generates a determining result. If the determining result is no, the electronic apparatus 100 is controlled to perform a first predetermined action according to the displacement of the palm H. If the determining result is yes, the electronic apparatus 100 is controlled to perform a deciding step, wherein the deciding step is utilized for deciding if a second predetermined action is performed according to a coordinates of the palm H at the end of the first predetermined time period. The electronic apparatus 100 may further include a display 105. In some embodiments, the display 105 may display different contents based on the gesture/action of the palm H. The electronic apparatus 100, however, is not limited to including the display 105.

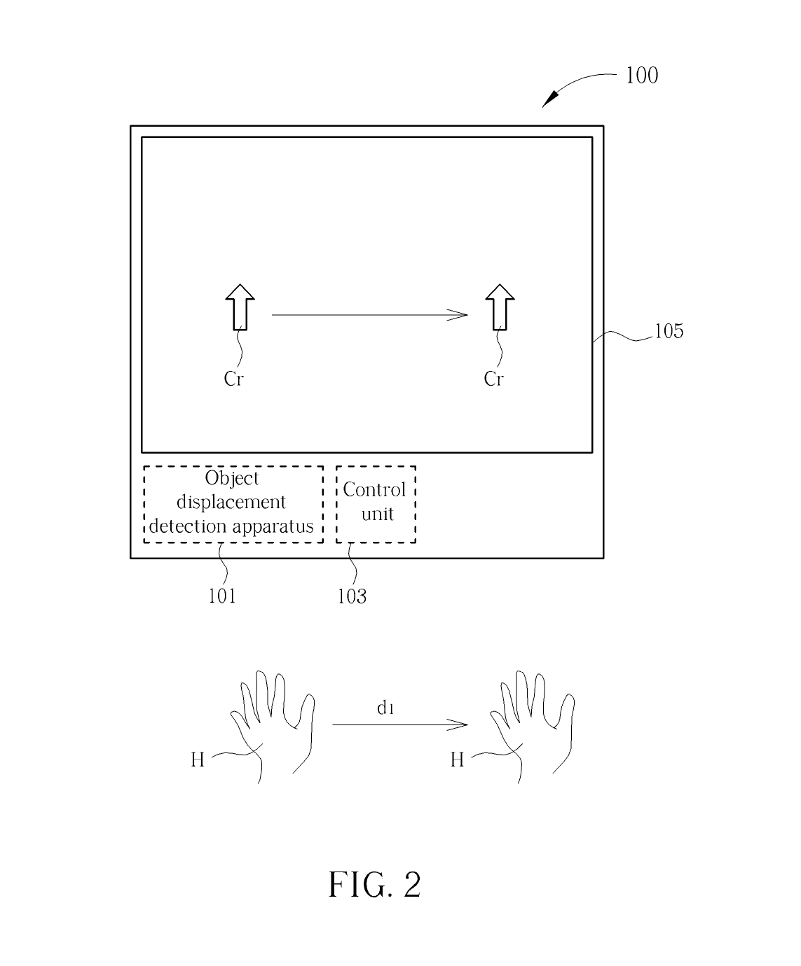

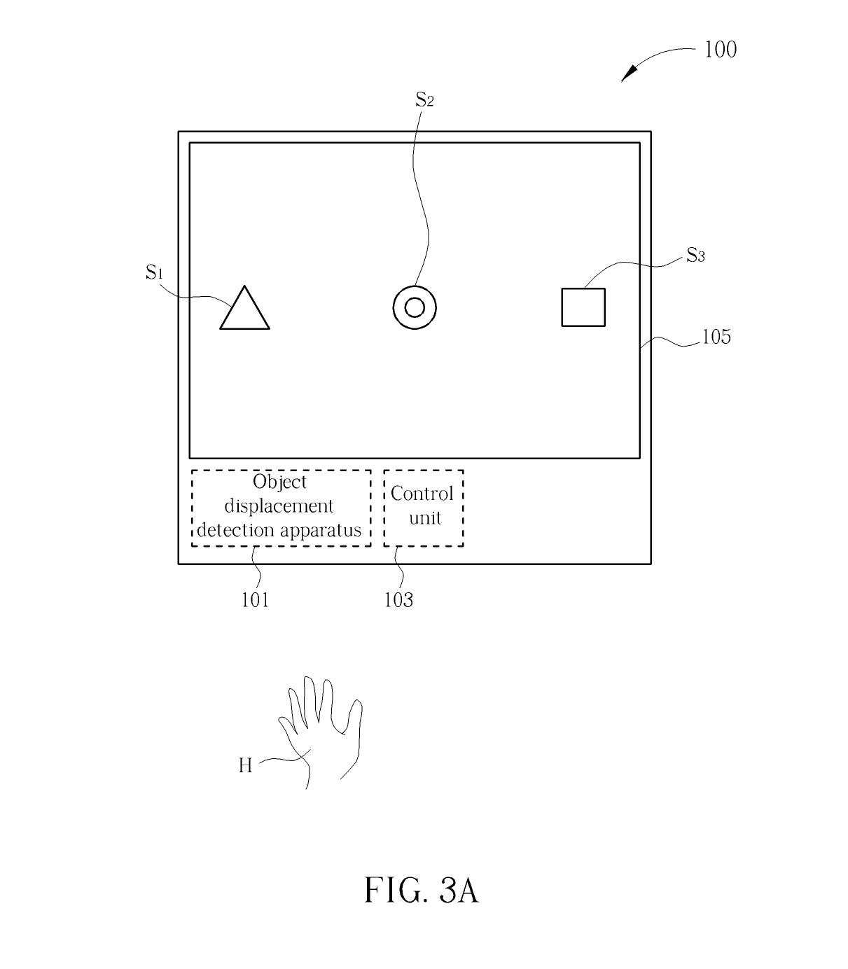

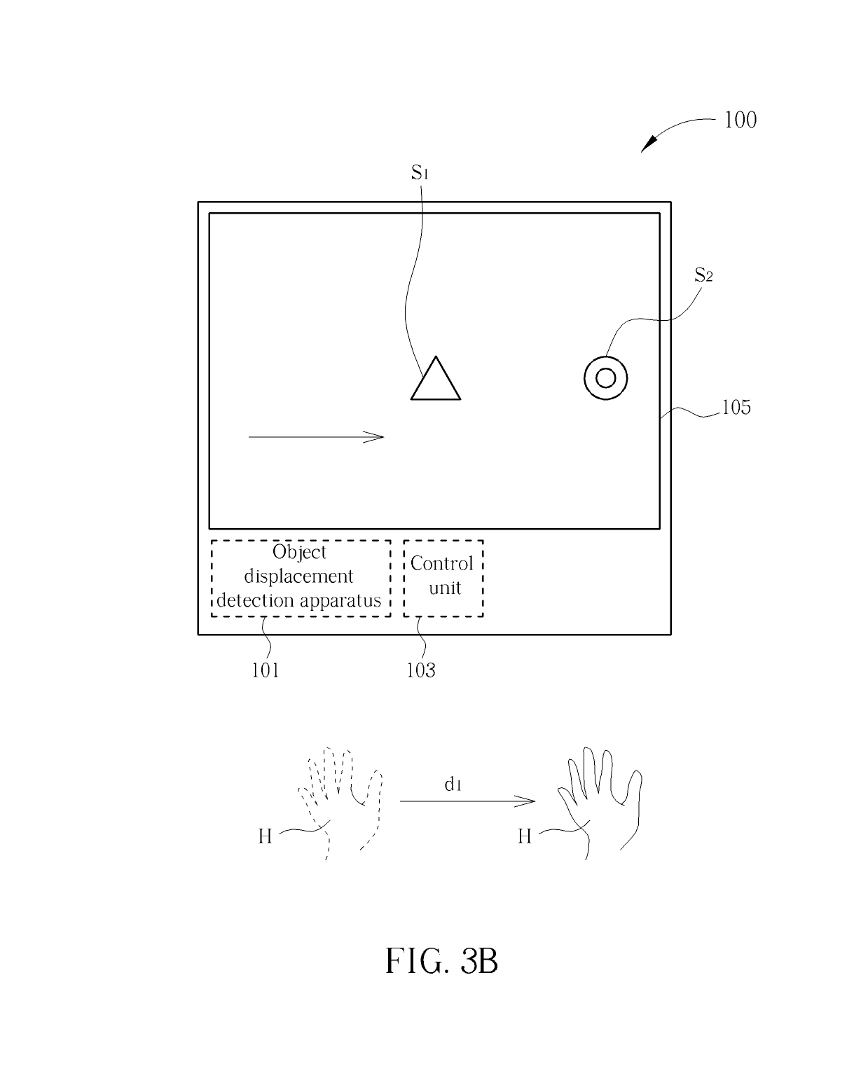

FIG. 2, FIG. 3A, and FIG. 3B are diagrams illustrating the first predetermined action performed by the electronic apparatus 100 shown in FIG. 1. In these embodiments, the aforementioned first predetermined action may be, but not limited to, moving a cursor or sliding a screen. Alternatively, the first predetermined action may be set as a different action. In the embodiment of FIG. 2, if a moving distance d1 of the palm H within the first predetermined time period is greater than the first predetermined distance, the cursor Cᵣ on the display 105 would move in response to the movement of the palm H. In the embodiment shown in FIG. 3A and FIG. 3B, the display 105 originally displays a screen (e.g., a photo or a web page), as shown in FIG. 3A. This screen has three different patterns S₁, S₂, and S₃ in this embodiment. In FIG. 3B, the moving distance of the palm H within the first predetermined time period is greater than the first predetermined distance d1. At this moment, the electronic apparatus 100 would be controlled to slide the screen displayed by the display 105 rightwards in response to the movement of the palm H. Thus, the screen shows the patterns S₁ and S₂ only.

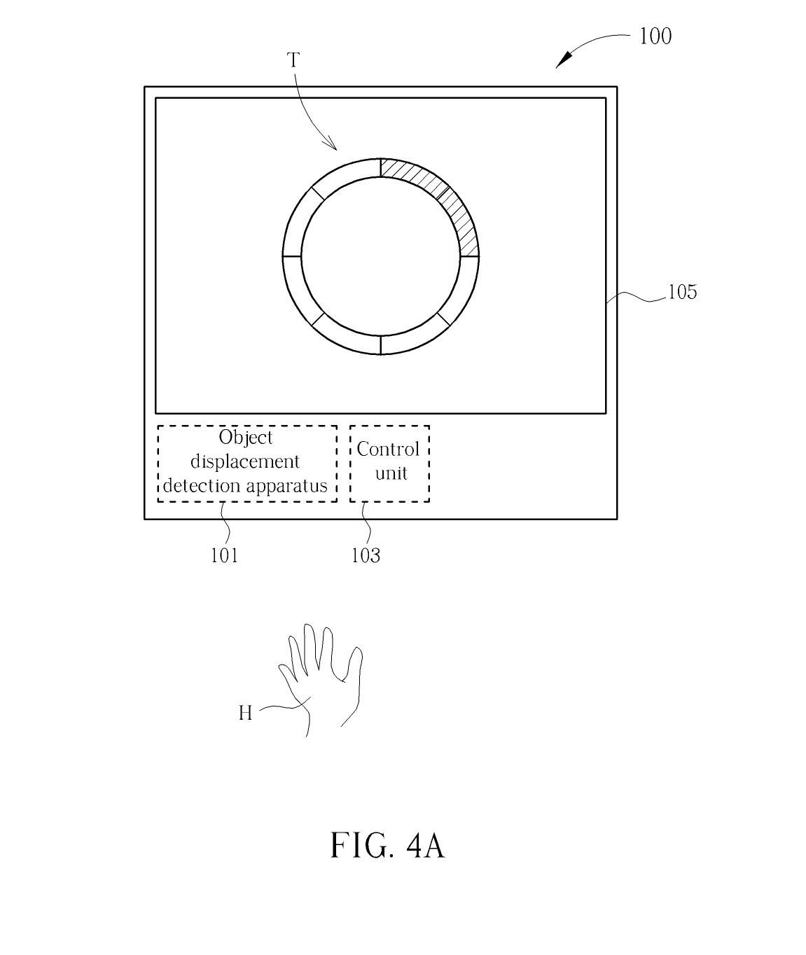

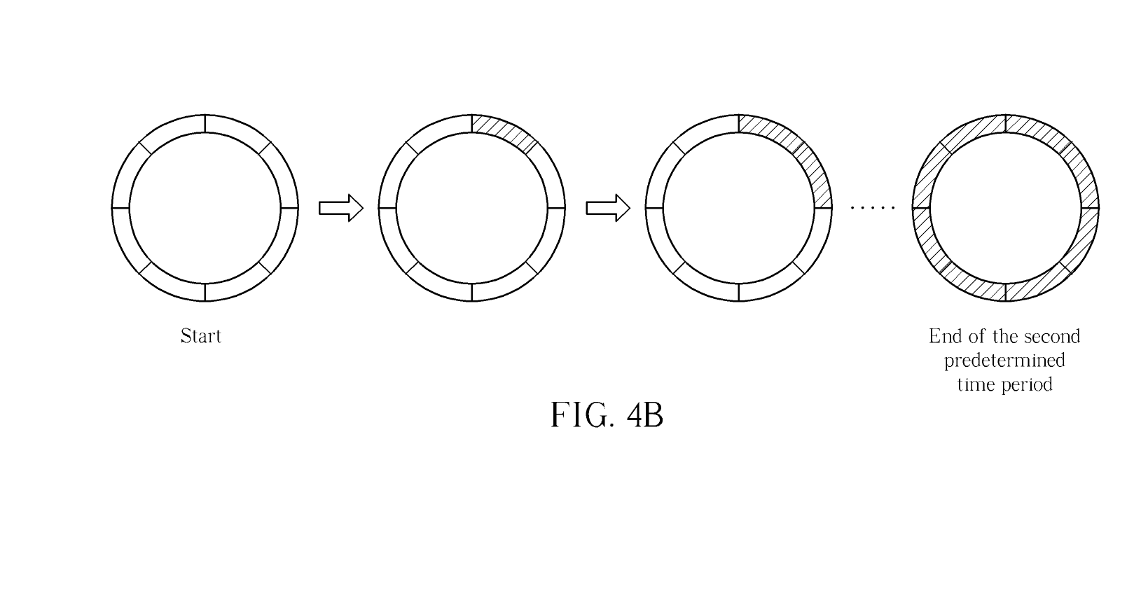

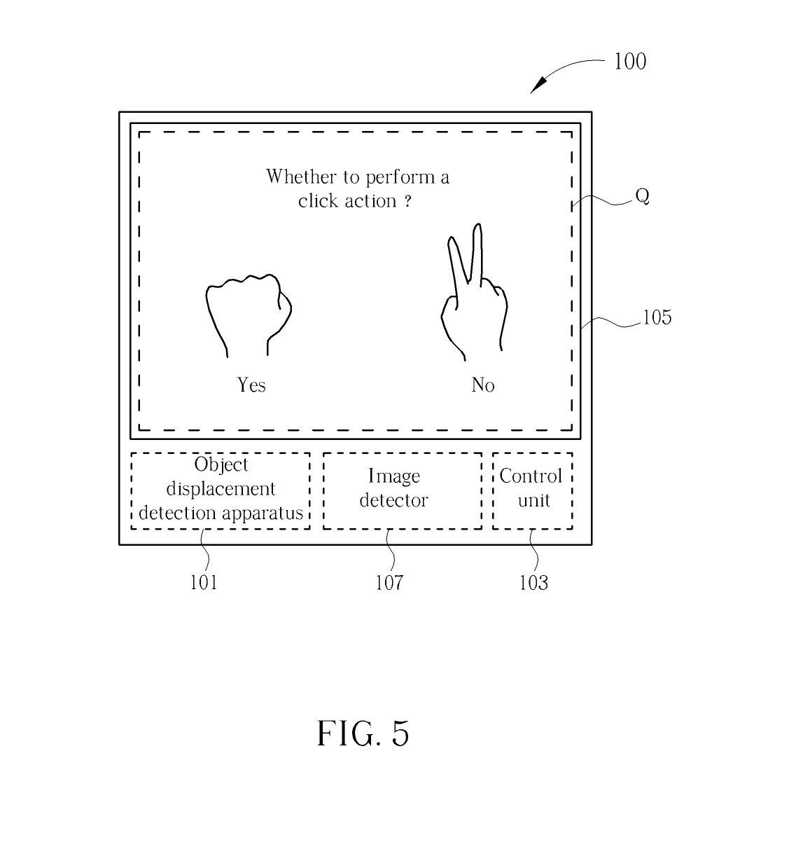

FIG. 4A, FIG. 4B, and FIG. 5 are diagrams illustrating the deciding action performed by the electronic apparatus 100 shown in FIG. 1. In these embodiments, the aforementioned second predetermined action may be, but not limited to, a click action. Alternatively, the second predetermined action may be set as a different action. The click action may be generated/triggered by clicking a button of a mouse which acts as an input interface of the electronic apparatus 100, or by touching the touch interface which acts as an input interface of the electronic apparatus 100. Please note that, in the embodiments of FIG. 4A, FIG. 4B, and FIG. 5, the palm H does not move (i.e., the palm H is still) within the first predetermined time period, such that the movement thereof must be less than the first predetermined distance. Therefore, the electronic apparatus 100 would perform the deciding action. However, if the palm H does move to have a displacement within the first predetermined time period and the displacement is less than the first predetermined distance, the electronic apparatus 100 would also perform the deciding action.

In the embodiment shown in FIG. 4A and FIG. 4B, the deciding action includes controlling the electronic apparatus 100 to display a timer T, which displays different statuses corresponding to a second predetermined time period. However, the displayed timer T is not limited to the circle pattern shown in FIG. 4A and FIG. 4B. As shown in FIG. 4A, the timer T may have a blank pattern in the beginning. As time elapses, the blank parts of the pattern are gradually filled. When the pattern is fully filled, it means that the second predetermined time period is expired. If the control unit 103 detects that the displacement of the palm H within the second predetermined time period is less than a second predetermined distance, the electronic apparatus 100 is controlled to perform a click action according to the coordinate of the palm H at the end of the first predetermined time period or the second predetermined time period. Please note that the coordinate at the end of the first predetermined time period represents the coordinate of the palm H at the time the timer T is started, and the coordinate at the end of the second predetermined time period represents the coordinate of the palm H at the time the timer T is expired. Therefore, if the palm H does not move within the second predetermined time period, the two coordinates would be the same. Thus, no matter which coordinate is employed to perform the clicking action, the same result is obtained. However, if the palms H moves within the second predetermined time period (but the moving distance is still less than the second predetermined distance), the two coordinates would be different and make the coordinates of the click actions different. Furthermore, the coordinate (s) may be determined according to some or all location information of the object within the first or the second predetermined time period (e.g., average coordinate(s)), and the second predetermined action may be performed based on such coordinate. The method for deciding the coordinate where the clicking action takes place can be pre-determined to meet user's requirements.

In the embodiment of FIG. 5, the deciding step includes controlling the electronic apparatus to display an inquiry screen to inquire whether to perform the clicking action. The electronic apparatus 100 includes an image detector 107 to detect the gesture of the palm H, and the control unit 103 is arranged for determining whether to perform the clicking action according to the detected gesture. For example, if a fist gesture is made when the inquiry screen Q shown in FIG. 5 appears, this indicates that the user agrees with the click action. If a “V”-shaped gesture is made when the inquiry screen Q shown in FIG. 5 appears, this indicates that the user does not agree with the click action. Please note that the gestures representative of “Yes” and “No” are not limited to those illustrated in the embodiment of FIG. 5. For instance, the user may apply a circling gesture to confirm the execution of the clicking operation. Moreover, after the inquiry screen appears, it may be determined whether to perform the clicking operation by using means other than gestures. For example, the click action may be performed automatically if there is no action after the inquiry screen appears for a period of time.

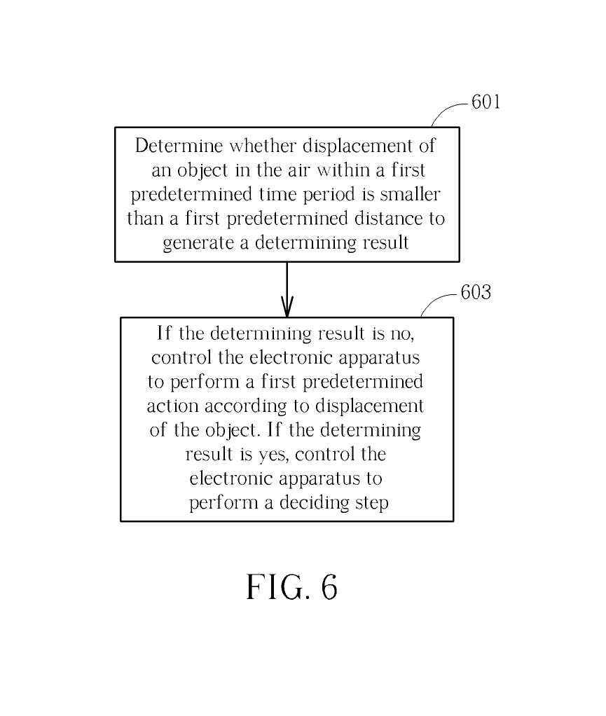

According to the aforementioned embodiments, an electronic apparatus control method is obtained, which includes steps as shown in FIG. 6.

Step 601: Determine whether displacement of an object in the air within a first predetermined time period is smaller than a first predetermined distance to generate a determining result.

Step 603: If the determining result is no, control the electronic apparatus to perform a first predetermined action. If the determining result is yes, control the electronic apparatus to perform a deciding step (as shown in FIG. 4A, FIG. 4B, and FIG. 5), wherein the deciding step is utilized for deciding whether to perform a second predetermined action according to a coordinate of the object at the end of the first predetermined time period.

As can be known from the aforementioned embodiments, the shortcomings (i.e., difficulty in performing a click action) in the conventional somatosensory technology can be improved, and the deciding action can be set based on user's habits for making the user feel more convenient in manipulating the electronic apparatus.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic apparatus control method, comprising:
determining if a displacement of an object in the air within a first predetermined time period is smaller than a first predetermined distance, and accordingly generating a determining result; and
if the determining result indicates that the displacement of the object in the air within the first predetermined time period is not smaller than the first predetermined distance, controlling the electronic apparatus to perform a first predetermined action; if the determining result indicates that the displacement of the object in the air within the first predetermined time period is smaller than the first predetermined distance, controlling the electronic apparatus to perform a deciding step, wherein the deciding step is utilized for deciding whether to perform a second predetermined action according to a coordinate of the object at an end of the first predetermined time period.

2. The method of claim 1, wherein the deciding step comprises:
controlling the electronic apparatus to display a timer which displays different statuses corresponding to a second predetermined time period; and
if the displacement of the object within the second predetermined time period is less than a second predetermined distance:
performing the second predetermined action according to the coordinate of the object at the end of the first predetermined time period or at an end of the second predetermined time period; or
performing the second predetermined action according to the coordinate obtained from some or all location information in the first or the second predetermined time.

3. The method of claim 1, wherein the deciding step comprises:
controlling the electronic apparatus to display an inquiry screen to inquire whether to perform the second predetermined action.

4. The method of claim 3, wherein the object is a palm; and the deciding step comprises:
after displaying the inquiry screen, deciding whether to perform the second predetermined action according to a gesture indicated by the palm.

5. The method of claim 1, wherein the first predetermined action is moving a cursor or sliding a screen.

6. The method of claim 1, wherein the second predetermined action is a click action.

7. An electronic apparatus, comprising:
an object displacement detection apparatus, arranged for determining displacement of an object in the air; and
a control unit, arranged for determining if the displacement of the object in the air within a first predetermined time period is smaller than a first predetermined distance and accordingly generating a determining result; wherein if the determining result indicates that the displacement of the object in the air within the first predetermined time period is not smaller than the first predetermined distance, the control unit controls the electronic apparatus to perform a first predetermined action; and if the determining result indicates that the displacement of the object in the air within the first predetermined time period is smaller than the first predetermined distance, the control unit controls the electronic apparatus to perform a deciding step, wherein the deciding step is utilized for deciding whether to perform a second predetermined action according to a coordinate of the object at an end of the first predetermined time period.

8. The electronic apparatus of claim 7, wherein the deciding step comprises:
controlling the electronic apparatus to display a timer which displays different statuses corresponding to a second predetermined time period; and
if the displacement of the object within the second predetermined time period is less than a second predetermined distance:
performing the second predetermined action according to the coordinate of the object at the end of the first predetermined time period or at an end of the second predetermined time period; or
performing the second predetermined action according to the coordinate obtained from some or all location information in the first or the second predetermined time.

9. The electronic apparatus of claim 7, wherein the deciding step comprises:
controlling the electronic apparatus to display an inquiry screen to inquire whether to perform the second predetermined action.

10. The electronic apparatus of claim 9, wherein the object is a palm;
the electronic apparatus comprises an image detection arranged to detect a gesture of the palm; and the deciding step comprises:
after the electronic apparatus displays the inquiry screen, deciding whether to perform the second predetermined action according to the gesture.

11. The electronic apparatus of claim 7, wherein the first predetermined action is moving a cursor or sliding a screen.

12. The electronic apparatus of claim 7, wherein the second predetermined action is a click action.
